(19) United States
(12) Patent Application Publication
(10) Pub. No.: US 2014/0167917 A2
(43) Pub. Date: Jun. 19, 2014

(54) Disease Mapping and Infection Control System and Method

(71) Applicants: Niall Wallace, Arkell (CA); Holly Harten, Sault Ste. Marie (CA); Matt McPherson, Toronto (CA); Colin Furness, Ottawa (CA); Neil Watson, Newcastle (CA); Tom Vair, Sault Ste. Marie (CA); Paul Beach, Sault Ste. Marie (CA); Chris Sambol, Sault Ste. Marie (CA); Chuck Shannon, Sault Ste. Marie (CA)

(72) Inventors: Niall Wallace, Arkell (CA); Holly Harten, Sault Ste. Marie (CA); Matt McPherson, Toronto (CA); Colin Furness, Ottawa (CA); Neil Watson, Newcastle (CA); Tom Vair, Sault Ste. Marie (CA); Paul Beach, Sault Ste. Marie (CA); Chris Sambol, Sault Ste. Marie (CA); Chuck Shannon, Sault Ste. Marie (CA)

(73) Assignee: Infonaut, Inc., Toronto, ON (CA)

(21) Appl. No.: 13/133,193

(22) PCT Filed: Dec. 8, 2009
(86) PCT No.: PCT/CA2009/001776

§ 371 Date: Jan. 27, 2012

Related U.S. Application Data
(60) Provisional application No. 61/120,630, filed on Dec. 8, 2008.

(51) Int. Cl. H04Q 5/22

(52) U.S. Cl. 340/10.1

(57) ABSTRACT

The present invention is a system and method for disease mapping and infection control. It may collect data from many sources, including through the tracking of Entities and external sources. Such data may be analysed by the system and represented visually. The system further facilitates data modelling. The present invention facilitates calculations of risk and exposure to an infection posed to a person, location or community. The system may be used to test and monitor infection spread and control measures. It can further be configured so as to produce reporting based upon its data to produce information relevant to the creation of infection control policies. The reports may also be utilized to develop standards and measures to improve the operation response to an outbreak of infection within an Institution or a Geographical Area, at the syndromic or pandemic levels.

### FIELD OF INVENTION

This invention relates in general to the field of a disease surveillance, mapping and infection control system and method, and specifically to a system and method for tracking, mapping and predicting infection dissemination to improve operational response.

### BACKGROUND OF THE INVENTION

Disease surveillance, mapping and infection control have become priorities for hospitals and communities in the age of antibiotic-resistant bacteria and infectious diseases. Prior art includes manual responses to infection events, including interviews to determine the potential sources and vectors of infection as well as the potential risk for exposure to others. In addition, there exist infection reporting systems that manually or automatically integrate data from various systems for the purpose of monitoring positive tests for hospital acquired infection rates. Some prior art systems utilize Real Time Location Systems (“RTLS”) strictly for the purpose of tracking entities in hospitals.

One example of a known healthcare asset managment systems is that of Ekahau, Inc. which offers a radio frequency identification (“RFID”) service over Wi-Fi networks. This service focuses on asset tracking, safety and security, visitor tracking, workflow and resource management within an institution, such as a healthcare facility, military sites, government insitutions, and locations relevant to the oil & gas sector. It provides 2D-based output. The Ekahau sevice is facility-specific and is not applicable as an infection control system.

Another known asset management system is the Awarix Inc. system presently owned by McKesson Corp. This system applies Wi-Fi, RFID to track patients, staff, assets, offer capacity alerts and real-time bed turnover status. The system is specifically configured to increase patient throughput and decrease wait times. The output of the system is 2D-based. The McKesson product is intended to be utilized within a particular institution. It is not applicable as an infection control tool.

Momentum Healthware, Inc. also offers a healthcare intersection tracking system that incorporates a RFID-based system. The Momentum system is intended to integrate nurse calls, security and asset management systems to track patient movement, wait times and locations within a facility. The system output is 2D-based with computer aided design floorplan drawings. The Momentum system is not applicable as an infection control tool.

Yet another example of known prior art in the area of healthcare tracking is that of Sonitor Techologies AS which offers RFID solutions and develops, manufactures and supplies an ultrasound indoor positioning system that tracks real-time 3-D location of moveable assets and individuals. The Sonitor system constitutes hardware designed to integrate with other software systems, and has the potential to function with geographic information system (“GIS”) environments and analysis modules.

Tele-Tracking Technologies, Inc. also offers a software product to track assets within a hospital environment. The Tele-Tracking product involve RFID systems and includes software that facilitates tracking of beds, management of patient flow, automation of patient transport, tracking of work orders and tracking of patient procedures. The software is limited to use within a single facility. The Tele-Tracking software is not applicable as an infection control tool.

Asset position determination means are known in the prior art and are described in the following patents: U.S. Pat. No. 7,336,563 disclosing the use of an identification tag that emits a signal to determine the position of a moving object that the tag is attached to; U.S. Pat. No. 7,352,652 disclosing using identification tags and radio waves with ultrasonic waves; U.S. Pat. No. 7,149,531 disclosing a location estimation module for estimating a terminal's location based on signal values at a radio interface; U.S. Pat. No. 7,349,683 disclosing the use of a location estimation module comprising a probablistic model to estimate a target's location based on observations; U.S. Pat. No. 7,299,059 disclosing creation of a graph to estimate a target's location in a radio network; U.S. Pat. No. 7,228,136 disclosing a method for estimating a reciever's location in a wireless comunication environment; U.S. Pat. No. 7,209,752 disclosing a method for determining an error estimate concerning a target device's location; U.S. Pat. No. 7,196,662 disclosing a model construction module for constructing a probabilistic model of a wireless environment wherein the inverse cumulative distribution functions of expected signal values at various locations are combined; U.S. Pat. No. 7,362,656 disclosing a method and system for monitoring and position determination of objects and/or living beings within an area using a plurality of identification tags equipped with an ultrasonic receiver and radio transmitter; US Patent Application No. 2005/0181804 disclosing a location estimation module for estimating a target device's location based on signal values at the radio interface; and US Patent Application No. 2008/0049555 disclosing a method and system for detection and position determination of chips which transmit ultrasound signals in a room.

Patient information transfer means are also known in the prior art and are described in the following patents: U.S. Pat. No. 6,757,898 discloses the generation of personalized patient pages that include information such as follow-up instructions, general inquiry answers, prescription re-fills, directions to the office of other healthcare facilities, etc.; US Patent Application No. 2007/0094045 discloses a notification of a message in a health care environment displayed on a graphical user interface that may be updated in real time; and US Patent Application No. 2005/0060201 discloses an ePackage constructed and stored on a hospital's node database to deliver and receive information electronically between organizations or sites.

A known system specifically configured for infection control application is the Infection Monitor Pro product of RadicaLogic Technoliges Inc. This includes infection control software that provides real-time surveillance of a hospital via a web-based system. The software further generates reports and infection risk alerts based on automated surveillance of hospital subsystems. Infection Monitor Pro does not include a facility for tracking the Intersection of patients, staff, or assets. The surveillance of Infection Monitor Pro is limited to a single facility.

### SUMMARY OF THE INVENTION

In one aspect, the present disclosure relates to a method for infection control characterized in that it comprises the steps of: collecting data pertaining to a risk of infection as related to one or more Entities within a Geographic Area from one or more data sources, including data generated by an Entity tracking means; utilizing a computer operable to implement a computer program capable of accessing the collected data to produce an analysis of a risk of infection relating to the one or more Entities; and generating one or more communications of the analysis of the risk of infection.

In another aspect, the present disclosure relates to a system for infection control characterized in that it comprises: one or more data collection means; an Entity tracking means, operable to track one or more Entities within a Geographic Area and produce Entity tracking data; a computer linked to an input means and a display means the computer being further linked to the one or more data collection means and the Entity tracking means; a computer program implemented by the computer the computer program being able to access the data of the one or more data collection means and the data of the Entity tracking means and to utilize said data to produce an analysis of a risk of infection relating to one or more Entities; and a communication facility connected to the computer whereby the analysis of the risk of infection may be transferred to the communication facility being operable to generate one or more communications of the analysis of the risk of infection.

In yet another aspect, the present disclosure relates to a computer program product for infection control characterized in that it comprises: a computer program implemented by a computer, the computer program being operable to produce an analysis of a risk of infection relating to one or more Entities, said computer program incorporating the following; a Business Intelligence Layer operable to collect data from one or more data sources by way of one or more data collection means and to transfer said collected data to the computer; an Entity Management Tool operable to accept the collected data transferred to the computer by way of the Business Intelligence Layer, and also operable to facilitate an Entity tracking means to generate Entity data relating to the movements of one or more Entities; and a Performance Analysis Tool operable to analyze collected data and Entity data of the Entity Management Tool to produce infection risk output and communicate said infection risk output to a user.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

The invention will be better understood and objects of the invention will become apparent when consideration is given to the following detailed description thereof. Such description makes reference to the annexed drawings wherein:

FIG. 1 is a diagram of the Infection Control Tool as it may be configured to function in an institutional environment.

FIG. 2 shows the data flow of a risk analysis involving data relating to an institution.

FIG. 3 shows an example of an analytical matrix for assets.

FIG. 4 shows an example of an analytical framework for patients.

FIG. 5 is a flow chart of the Infection Control Tool as applied in an Institution.

FIG. 6 is a system diagram of components of the invention.

In the drawings, embodiments of the invention are illustrated by way of example. It is to be expressly understood that the description and drawings are only for the purpose of illustration and as an aid to understanding, and are not intended as a definition of the limits of the invention.

### DETAILED DESCRIPTION OF THE PREFERRED EMBODIMENT

The present invention is a system and method for disease surveillance, mapping and infection control. The present invention may collect data from many sources, such as, for example through the current and historical location tracking of Entities, internal sources, external sources and any other source. The collected data may include clinical data, location data or other data. Such data may be analysed by the system and represented visually. Such analysis may track exposure to and risk of contracting an infection. The analysis may be an infection risk analysis, a review of an infection control policy, or other analysis relating to infection spread and control. The system further facilitates data modelling and simulation of infection spread and control.

The description of the present invention herein will apply the following terms. A skilled reader will recognize that the definitions presented for each term includes examples of possible definitions and that other components may be incorporated into each definition.

“Entity” means a patient, staff, asset (for example, such as equipment within a hospital), community member, student, visitor, other person, location (for example, such as a room, zone or coordinate point) or other unit that can be tracked.

“Intersection” means contact or physical proximity between Entities that may be direct, indirect, fluid or airborne.

“Geographical Area” means a zone, room, Institution, country, region, coordinate point, or other geographic location.

“Institution” means a building, facility, hospital, government office, shopping complex, office building, school, church, resort, cruise ship, or other contained area.

The present invention may facilitate analysis of data and/or calculations, to produce an output that relates to infection control, such as the risk of contracting an infection or the risk of exposure to an infection posed to an Entity, such as, for example a person. The present invention may further analyze or calculate risk of exposure to an infection relating to the pathogenic properties of a piece of equipment or location, interaction between an Entity and an infected person, or location of an Entity within a Geographic Area, such as, for example an Institution as a whole, or any part of an Institution. A part of an Institution may be, for example a particular floor of a hospital. The system may additionally be operable to test and monitor infection spread and control measures. It may produce a risk calculation, or may be configured so as to produce reporting, or any other communication, based upon collected data. The risk calculation, reporting, other communicate, and collected data may be utilized to generate information relevant to the creation and measurement of infection control policies. The reports or communications may also be utilized to develop and monitor policies, standards and measures to improve the operational response to an incident of infected persons, equipment or location within a Geographic Area.

One embodiment of the present invention may utilize Real Time Location Systems (“RTLS”), such as radio frequency identification (“RFID”). This may facilitate location and movement monitoring of Entities, such as, for example a person or an asset. RTLS data may be utilized to find and locate Entities within a Geographical Area, or generate location awareness and monitoring of operational flow within a Geographical Area. For example, the present invention may address the integrated data from various systems and RTLS, such as RFID, in clinical environments to allow time, location and movement monitoring of various entities and locations for the purpose of infection or disease surveillance, mapping and infection control. Additionally, the invention may utilize geographic information system (“GIS”) software. GIS software may be applied with various systems and data to capture, integrate and present data in reference to infection control for entities and specific Geographic Areas, such as, for example a hospital. Another embodiment the present invention is a system and method for infection control that may comprise a data collection means. Data may be collected from databases that are internal or external to a Geographic Area and/or the system. A computer may be included in the system whereby data or commands may inputed to the system and output data may be displayed. The computer may be operable to facilitate the implementation of a computer program that is able to access the data stored in the one or more internal and/or external databases and utilize said data to analyze or calculate a risk of infection relating to one or more Entities. The data of the system, including results of the analysis or calculation, may be reported or communicated to the computer or a mobile device. Data, including results of the analysis or calculation may be generated as a report that may include a visual representation of the risk of infection to one or more Entities.

The present invention involves the collection and analysis of data from multiple data sources relating to infection data. Such data may be collected from databases or be entered directly by a user and such data may relate to an Entity, an infection, policies or procedures, or any other relevant information. The data may include data relating to specific Entities, such as, for example whether such Entities have tested positive for an infection. Additionally, data may be collected from an Entity tracking system, whereby the historical and current movement of Entities, and any Intersection between Entities or proximity of an Entity to a particular location within a Geographical Area, may be recorded. Another data source may provide data relating to infection control policies and procedures of a Geographical Area, such as, for example an Institution. All of the data may be analyzed by the system to produce a variety of outputs, such as, for example a risk rating relating to one or more Entities or a particular location within a Geographical Area.

The analysis output may be shown in a visual representation such as a map which may indicate hot zones of infection. Such a hot zone may indicate Entities that are high risk (for example the location of infected Entities) or a location where infection pathogens exist. The output may show infection rates or spread over a lapse of time, or infection rates in real time (or near real-time), or a projected spread of infection. Spread of infection can occur through the Intersection of infected Entities with non-infected Entities, or proximity of one or more Entities to a hot zone location. Through a review of the visual representation a user may learn of infection locations and the rate of the spread of infection. The output may further facilitate a review of the efficacy of infection control policies or procedures. The system may function based upon a variety of data collected from a variety of sources, such as, for example data recorded from present or past infection incidents, simulation data, or upon a mixture of types of data.

The present invention presents an improvement over the prior art. Existing known hospital systems provide baseline patient and asset data. The information of such systems is often extracted from existing data sources.

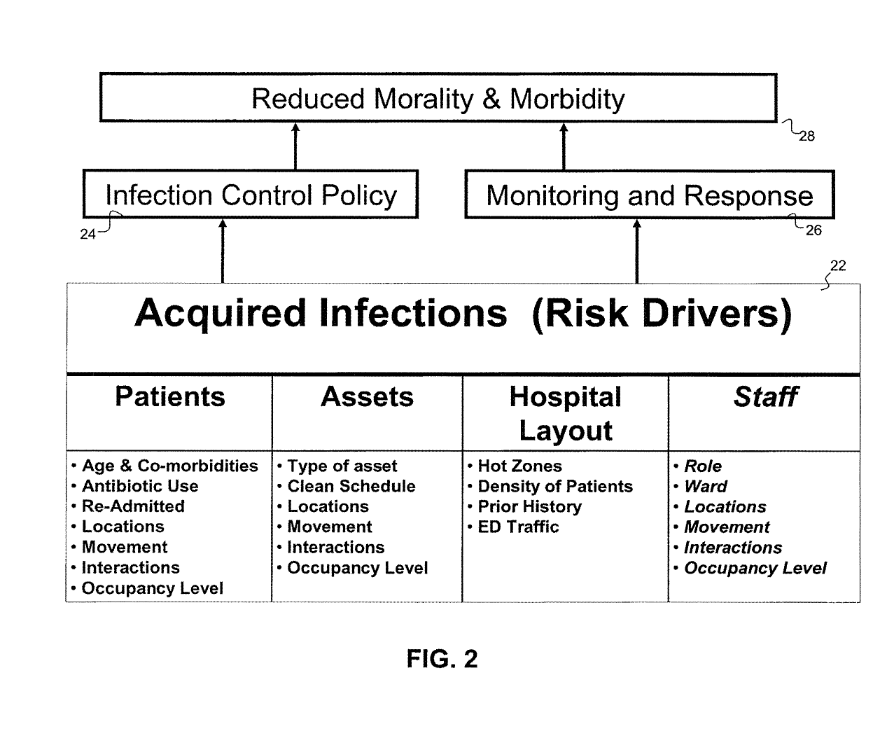

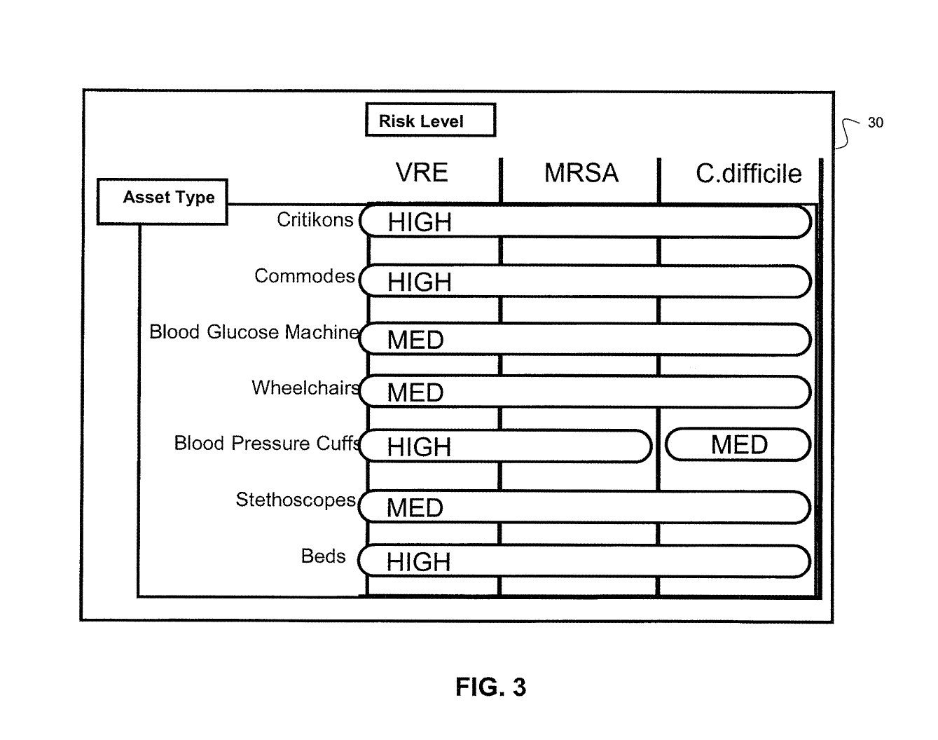

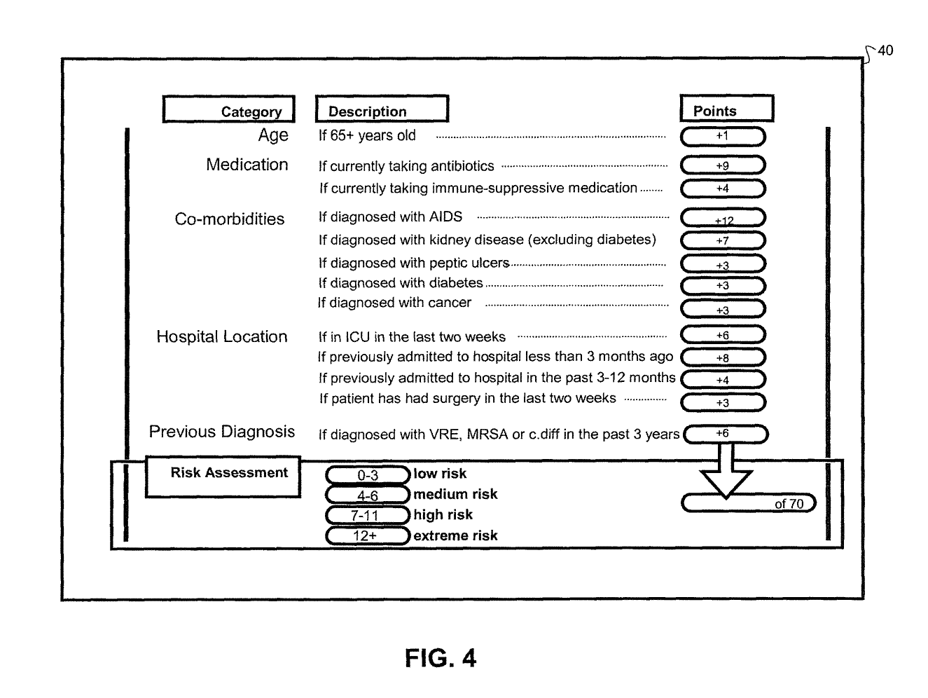

The present invention provides a benefit over the prior art as, it may utilize the Business Intelligence Layer to calculate various risk exposures that quantify the risk for infectious diseases existing within a facility. As examples, the present invention may quantify: risk factors, as shown in FIG. 2; asset risk, as shown in FIG. 3; and/or patient risk calculations, as shown in FIG. 4. A skilled reader will recognize that FIGS. 2-4 present examples of possible risk quantifications and that other risk quantifications may also be performed by the present invention.

Such calculations may be delivered to a user via the Internet, through an internal server, or by way of other transfer means. The present invention may collect data relating to an Entity through the use of real-time locating systems (“RTLS”). The RTLS may be of many forms, including one that uses RFID tags, a sonar system, or other types, as will be apparent to a person skilled in the art. The RTLS may utilize tags that attach to Entities. Tag signals may be detected and picked up by a RTLS system at regular intervals. The system may record time, location, and movement data and send this information over a network to GIS software to calculate spatial intersections. The present invention may integrate Geographical Area infection-control best practices, Entity risk factors, location, movement, spatial Intersections, outbreak connection and relevant operational data and information into its risk calculation. This data may be analyzed to enable a Geographical Area to understand Geographical Area level infectious disease risk exposure and to effectively prioritize infection control practices related thereto.

An additional benefit of the present invention over the prior art is that it can function beyond the boundaries of a single Institution. One embodiment of the present invention may be applied so as to encompass a wider Geographical Area (for example, such as a country rather than a community). This sphere may include multiple Institutions, multi-site Institutions, or a plurality of Institutions governed by a single body, for example, such as facilities within a care community. The present invention may be utilized to collect data relevant to the infection-control best practices, persons in the Geographical Area risk factors, location, movement, spatial Intersections, outbreak connection and relevant operational data and information. It may further provide data relating the effect of the practices of a particular Institution upon the Geographical Area as a whole. Such data can facilitate the coordination of infection control policies and procedures of a Geographical Area in the case of a pandemic, for example, such as SARs or H1N1 influenza.

The present invention represents several other benefits over the prior art. Prior art systems can track Entities and provide two dimensional (2D), three dimensional (3D) or other forms of mapping, but are configured to do so within an institutional environment. Embodiments of the present invention that function in a wider sphere than a single Institution may be used to track the spread of an infection that has its outbreak in an Institution as a syndrome and provide analysis of its actual as well as its possible spread and rate within the community surrounding the Institution. This facility allows the present invention to be used as a tool to curb infection before it spreads. The present invention can further provide a means of calculating the risk of infection to people, such as patients and community members. This information can further be translated into infection spread policy and Entity management policies to avert, curtail, or at least diminish infection dissemination.

An additional benefit of the present invention over the prior art is the ability model the risk of exposure to an infection within a Geographical Area. Such modeling may incorporate variables that allow the system to be utilized for predictive models. For example, such as variables relating to an infection that is considered likely to affect a Geographical Area. The application of variables may allow users to analyze several possible processes and outcomes of the spread of an infection or disease, including infections and diseases that have not previously affected a particular Institution or Geographical Area.

Another benefit of the present invention over the prior art is that the data gathered from its application in as either a historical, real-time or predictive tool may be used to guide daily infection control. Embodiments of the present invention may track, calculate, and monitor patient risk of exposure to infection and produce infection management response reports. The present invention may be utilized as a decision support tool for determining infection risk by monitoring hospital infection control policy compliance, providing up-to-date situation awareness and direct targeted risk-mitigation strategies, and by informing infection control policy for the purpose of improving such policy. The present invention may also provide guidance to operational management and response by focusing on daily patient-centric infection control.

One embodiment of present invention facilitates one or more risk assessments. In an embodiment of the present invention that involves multiple risk assessments these may be a combination of multiple risk sub-assessments that may be applied to produce a total risk calculation. These risk sub-assessments may be performed to incorporate data collected by the system on-the-fly (for example upon request, such as a user request), on a scheduled basis, and/or on a continual basis. The risk sub-assessment calculation may also occur on-the-fly, on a scheduled basis, and/or on a continual basis. A skilled reader will recognize that additional risk sub-assessments to those described herein may be applied by the present invention and that those presented in this document are merely examples.

In an embodiment of the present invention, one such risk sub-assessment may involve an understanding of the characteristics relating to an Entity. The system may utilize data relating to an Entity, such as, for example clinical data relating to a patient, to calculate a risk of infection for said Entity. For example, if the Entity is a patient in a hospital environment, the age of the patient, whether the patient is taking antibiotics, and other factors may be included in the data collected and applied in the risk calculation. The result of the calculation will be an indicator that marks the risk of infection pertaining to the Entity. The indicator may be presented in many forms, such as, for example as an overall score, a percentile, or it may further be translated to a standardized indicator, for example, such as high, medium or low. A skilled reader will recognize that a variety of possible data, and initial and translated indicators, may be utilized by the present invention to facilitate this sub-assessment.

Another risk sub-assessment may include an evaluation of the location, movement and Intersection of Entities. For example, within a hospital environment, data utilized for such a sub-assessment risk calculation may include the location of a patient related to any hot zone infection area(s) within the hospital, the movement of a patient from one location in the hospital to the other, the Intersection of the patient with any hospital equipment that has been in contact with other infected Entities, and/or the Intersection of the patient with other infected Entities that are patients. A skilled reader will recognize that these examples represent a limited number of possible data that may be relevant to this risk sub-assessment.

Yet another risk sub-assessment that may be applied by the present invention pertains to an environment, for example, such as a Geographical Area, or a sub-area located therein. Such an assessment considers any outbreak of infection occurring within that environment. A location of an outbreak may be deemed a hot zone. For example, in a hospital the location and/or environment may be a specific room where a patient testing positive for an infectious disease is located.

A variety of risk sub-assessments may be applied by the system and these may be incorporated into an overall total risk calculation. The total risk calculation may provide an output that indicates the risk of infection pertaining to an Entity. A skilled reader will recognize that the process of risk sub-assessment and total risk calculation may be applied to a Geographical Area as well as to an Entity.

One embodiment of the present invention, may allow a user to utilize a computer terminal, or other input means, to input data, to cause the generation of data, the transfer of data, the processing of data, the analysis of data, to request a visual representation of infection control data and/or to perform other steps to facilitate the system and method of the present invention. For example, the user may utilize a computer linked to a local server to access data or alternatively a computer may also be configured to access data via the Internet. Such an embodiment of the present invention may include access to one or more servers wherein data may be stored, such as, for example data collected via an RTLS, data collected from user input and/or from external data sources. Another embodiment of the present invention may incorporate one or more databases that may be located remotely from one another. The databases may even be owned and operated by multiple Institutions.

An example of data collection in a hospital environment may involve the collection of patient data. In this embodiment data may be collected at the point of patient admission and this may be inputted into the computer via a keyboard by a hospital staff member. Patient data may further include initially, or by way of additions thereto, nursing reports, doctor reports, room assignment, meals, medication administration, test results and other information relating to the patient's treatment and experience while in the hospital. Patient data may also be received from one or more external data sources, such as a database of a hospital where the patient attended previously. Information relating to hospital infection control policies and procedures may also be entered into a computer and stored as data in the servers or accessed from a remote data source. Additionally, the patient may be provided with a RTLS tag to be worn by, or otherwise attached to, a patient while the patient is in the hospital, and hospital equipment may also be provided with RTLS tags, such as, for example RFID tags attached to the equipment. One or more of the present invention servers may store the patient information, data collected from the RTLS system and any other collected data.

In another embodiment of the present invention visual representation of infection control data may be generated by a GIS utilizing the data stored in the servers of the present invention and/or servers accessible by the present invention. A skilled reader will recognize that a visual representation, or any other report or representation of data, may be generated on the basis of a user request, at a specific point in time, based upon a schedule, automatically based upon a particular occurrence, or upon any other basis. The generation process may involve the undertaking of risk calculations or other analysis. The visual representation may be a variety of outputs. For example, if the Geographical Area is a hospital, a visual representation may be a map of the hospital having indicators of hot-spots of infection within the hospital, showing the location of infected entities, showing the location of entities at risk of infection and/or showing the spread of infection over time. A skilled reader will recognize that a variety of other visual and non-visual representations of data, calculations and/or analysis may be produced by the present invention, such as drawings, graphs, text reports, etc.

One embodiment of the present invention may include a GUI interface whereby maps or other visual representations of the data and calculations of the present invention may be displayed to a user. Such an interface may be operable to function to accept and incorporate data from sources such as the RTLS system whereby movement of Entities within a mapped Geographical Area, such as, for example an Institution that is a hospital, may be shown as occurring in the visual representation of the map in real-time (or near real-time), as historical data at a point in time or over a period of time, or to facilitate showing predicted movement of Entities, or historical or projected spread of infection. Additionally, other data output and report output means may be incorporated in the present invention to provide reporting and communication functionalities. A skilled reader will recognize that the hardware and software components and configuration thereof applied in embodiments of the present invention may vary depending on the application of the present invention.

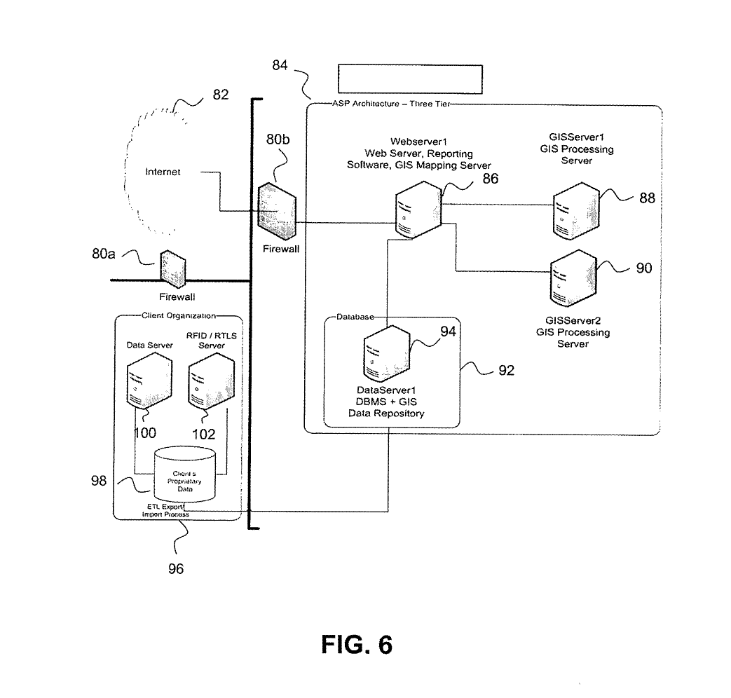

The present invention may be presented through hardware that facilitates availability of the system to: a single user; to a networked system within a Geographical Area, such as, for example an Institution; via an Intranet; or via the Internet. In the situation that the present invention is available through a configuration that presents the content thereof to multiple users, a security or privacy application may be incorporated into the system, such as, for example one or more firewalls. As shown in FIG. 6, one or more firewalls 80a and 80b, may be set-up to protect groups of components of the present invention, for example, such as between the Internet 82 and the other components 84 of the present invention. A skilled reader will recognize that this is but one embodiment of the present invention and that other embodiments are possible. Also a variety of software components may be utilized in the present invention, such as, for example software applications operable to facilitate the function of the present invention. For example, such as software components may include software applications to analyze data and facilitate the intersection, connectivity and inter-function of internal and external systems and databases, such as for example, systems and databases of other Geographical Areas.

In yet another embodiment of the present invention, the system may include several components to facilitate its function as an infection control tool. One or more servers may be utilized, including at least one data server, at least one RTLS server, and at least one web server. The data and RTLS servers may be operated through software, for example, such as, Server OS Software, and the web server may be operated through software, for example, such as Web Server OS Software. The servers and software may communicate with an RTLS, such as one that utilizes RFID tags. The RFID tags may be mounted upon Entities by way of mounting hardware or otherwise attached to Entities. For example, in a hospital environment the RFID tags may be mounted upon patient bracelets, beds, hospital equipment, or other Entities. One or more RTLS collectors and one or more RTLS detectors may be operable to sense the signals emitted by the RFID tags, and data relating to the RFID tag may be transferred to one or more of the servers.

Another component of the present invention may be GIS software whereby data, including location, as transferred from one of the servers may be utilized to generate a visual representation, such as a map, showing infection data that may include the rate of the spread of infection, the Intersection between Entities, or other relevant data. A variety of software applications may be utilized to generate a visual representation of a Geographical Area in a map format. The GIS software implemented in the present invention may include GIS Enterprise Server Software and GIS Data Server Software.

The present invention may also incorporate a display means, for example, such as a computer screen or mobile device. The system may also include a keyboard or other input means whereby information may be entered and thereby provided to the system by a user. Additionally, a computer may be integrated into the system and one or more internal and/or external databases may be accessed by the present invention for the purpose of uploading and downloading data. Components of the present invention may be connected through wireless means or by cabling, for example, such as shielded cabling or plenum cabling that may incorporate connectors, for example, such as Cat5 Connectors. The present invention may further be operable to provide data, communications, visual representation, reports, alerts or other output to the computer screen or to one or more mobile devices, such as, for example a cell phone, a personal data device, a Blackberry™, or any other mobile device.

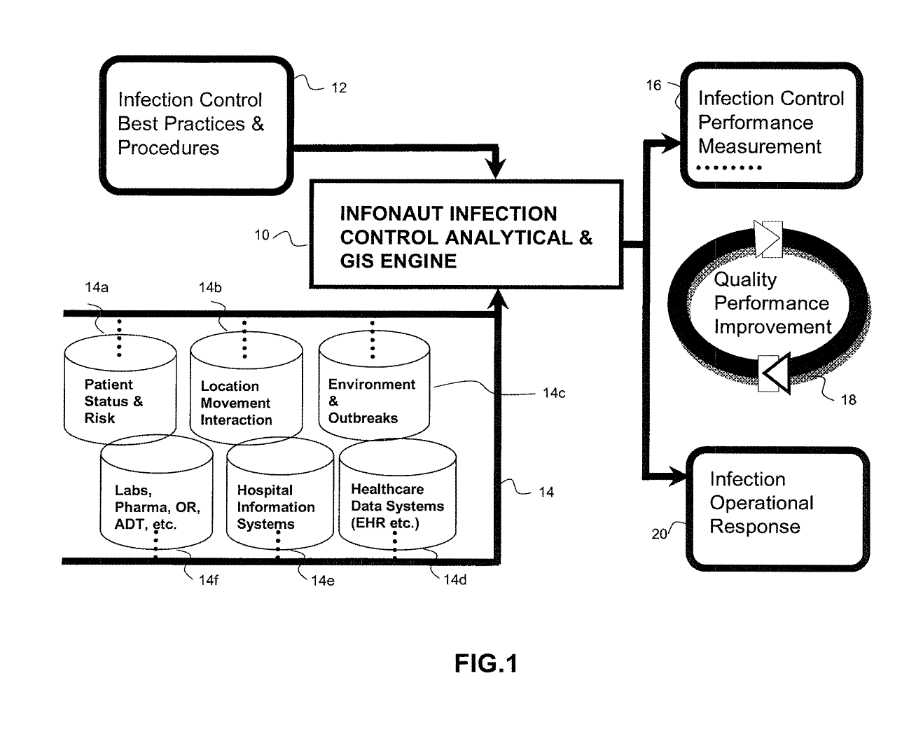

An example of a possible configuration of the system of present invention is shown in FIG. 1. An engine 10 may be operable to receive data and transmit data, such as, for example a GIS engine. Data relevant to policies, guidelines, best practices, regulations, rules, operations, management or other standards related to a specific Geographical Area 12 may be transferred to the engine. Transfer of such data may occur by way of user input, or other transfer means. Such data may be utilized by the engine to produce logic-based algorithms. Additionally data from one or more servers 14 may be transferred to the engine.

The servers may be internal to a Geographical Area or external to a Geographical Area. The data transferred from these servers may be transferred by a direct link, a wireless link, the Internet or other transfer means. The servers may include: patient status and risk database servers 14a; location, movement and interaction servers 14b which may be operable to communicate with a RTLS system and thereby transfer data generated by and related to the monitoring of Entities within a Geographical Area; environment and outbreaks servers 14c which may store data relating to the environment of the Geographical Area generally as well as prior outbreaks of infectious diseases; healthcare data systems 14d which may be a database for healthcare information pertaining to patients and health care services within a particular Geographical Area, or a portion of a Geographical Area, or an area outside the Geographical Area, or pertaining to a particular subset of patients, such as patients with a particular medical condition; hospital information systems 14e which may be a database for a particular hospital, or a collection of hospitals; laboratories, pharmacies, operating rooms, ADT servers 14f, which may be servers pertaining to individual or collections of laboratories, pharmacies, operating rooms, ADT within a Geographical Area or outside a Geographical Area. A skilled reader will recognize that other servers may be accessible by the system.

The engine may be operable to utilize the data transferred thereto to produce a variety of determinations, such as calculations, measurements, metrics, or other analyses, in accordance with logic-based algorithms. The output thereof may be reported or otherwise communicated to one or more persons by many means, such as email, text messages, notices appearing on a computer screen, printed reports, visual representations, or any other means. The logic-based algorithms may be created to produce a variety of determinations, such as, for example assessments of risk of infection pertaining to one or more Entities. The determinations may also provide a means of measuring conformance with policies, guidelines, best practices, regulations, rules, operations, management or other standards.

The engine may transfer data, such as the determinations or other data to a storage means, which may be located near to the engine or at a distance therefrom. The data, such as the determinations may additionally be transferred by the engine, or alternatively collected from the storage means, by way of a performance measurement tool 16. The performance measurement tool may be operable to produce reports or other communications to reflect performance measurements, such as an indication of conformance or lack of conformance with policies, guidelines, best practices, regulations, rules, operations, management or other standards. Additionally, the engine may transfer data, such as the determinations or other data, to an operational response tool 20. The operational response tool may be operable to produce reports or other communications to reflect any operational flow occurring during the spread of an infection within a Geographic Area, any operation response to the spread of an infection, any data derived from an analysis or examination of the data, such as, for example output regarding the efficacy of infection control policies or procedures.

Users to whom the performance measurement tool and/or the operational response tool provide reports or other communications may utilize such reports or other communications to determine means and methods of improving the quality of performance and operational response within a Geographical Area. This activity may produce quality performance improvement means 18, such as new or updated policies, guidelines, best practices, regulations, rules, operations, management or other standards to be applied to the Geographical Area.

As shown in FIG. 2, the present invention may be utilized to ascertain risk factors. It may further produce a report or other communication relating to possible responses to risk factors to reduce morbidity rates from such risks. In this embodiment the present invention may be utilized to focus upon a particular infection or disease. Data 22 may be gathered relating to: patients affected by the infection; staff responding to the infection; assets either in contact with the patients or staff, or in the region of the infection (e.g. hot zone); layout of a geographical area where the infection occurs; and any other data relevant to the infection. The data gathering means may include several means, such as data entry, RTLS tags, GIS system, transfer or retrieval from external databases, or other means. The data 22 may be relevant to a determination of risk drivers for infection. The data 22 may be utilized for two analytical purposes: to review and develop infection control policies 24; and to produce means of monitoring and responding to an infection 26. The outcome of the implementation of the infection control policies 24 and the monitoring and responding to the infection 26, may be a reduced mortality and morbidity as a result of the infection.

In one embodiment of the present invention the process of ascertaining risk factors may be circular, in that as more data 22 is gathered, the infection control policy development 24 and monitoring and response 26 may be further refined and updated. The result may be an ongoing decrease in mortality and morbidity due to the infection. Moreover, the process of ascertaining risk factors may be populated with assumed or created data for the purpose of utilizing the present invention as a predictive tool whereby it may generate a model operable to analyze the effects of certain data upon mortality and morbidity.

In another embodiment of the present invention, as shown in FIG. 3, an analysis of the risk of particular Entities as hotbeds of infection, such as assets within a Geographical Area that is a hospital, may be rated at a particular point in time. The rating may be in accordance with any scale, for example, such as a numeric scale, an indication of low, medium or high likelihood that the asset is an infection carrier, or any other scale. The rating for each asset may be determined in relation to a variety of data, such as positive tests of infection; the cleanliness of the asset; contact of the asset with an infected Entity; and/or the likelihood of an asset to collect and harbour infection. A single asset may be rated for a variety of infections, such as VRE, MRSA, and/or C.difficile. The rating of assets may be reported or otherwise communicated in a variety of forms and by a variety of means. An example of such a report is 30 of FIG. 3.

In yet another embodiment of the present invention, as shown in FIG. 4, a calculation of patient risk of infection may be produced. Such a calculation may involve several criteria collected as data by the present invention, or otherwise entered manually into the system by a user, as indicators of risk of infection. These criteria may be identified as according with particular categories, such as age, medication, co-morbidities, or other categories. In one embodiment of the present invention data relating to a patient may be utilized to respond to each criteria. The patient data may be collected from a variety of sources. For example, the patient data may be: collected from a hospital database, or other health care facility database; collected by the monitoring by way of the RTLS of the present invention; provided by the patient and entered into the system; or any other means of data collection. The patient data will be utilized to respond to the criteria and the response may be rated. The rating may be in accordance with any scale, for example, such as a points scale, an indication of low, medium or high, or any other scale. A final overall rating of risk of infection by a patient, which may reflect any rating scale, may be generated by the system. The rating of a patient's risk of infection may be reported or otherwise communicated in a variety of forms and by a variety of means. An example of such a report is 40 of FIG. 4.

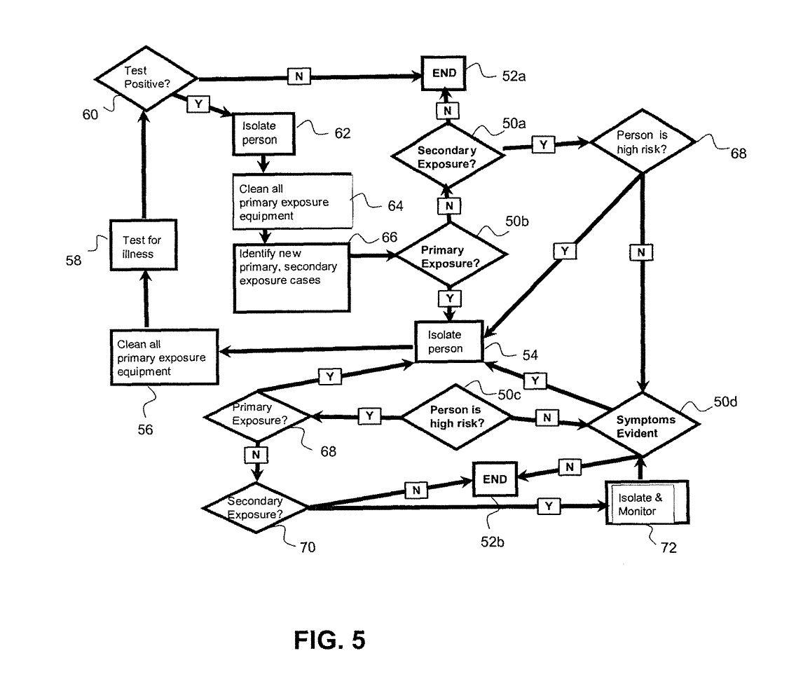

One embodiment of the present invention may involve processing of data in accordance with a particular logic flow. An example of a logic flow that may be applied to infection control decisions is shown as FIG. 5. The start of the logic flow may occur at a number of points, such as: review of a possible secondary exposure to infection 50a; review of a possible primary exposure to infection 50b; review of a potential person presenting a high risk of infection 50c; and review of a person for evident symptoms of infection 50d. The possible end points of the logic flow are represented as 52a and 52b. Generally the logic flow may consider any of the following points: whether to isolate a person; the results of tests for infection; and cleaning activities to diminish potential for infection.

Several logic flows resulting in a number of different decisions and/or activities may occur in compliance with the logic flow example shown in FIG. 5. These logic flows may represent possible analyses the system may perform. A skilled reader will recognize that the present invention is capable of applying a wide range of other logic flows, either focusing upon infection control, or other considerations. Based upon the example shown in FIG. 5, the identification of a potentially infectious entity may lead to a review as to whether primary exposure has occurred 50b, if the answer to this question is yes then a decision to isolate the potentially infected person 54 may be made and acted upon. A further decision to clean all primary exposure equipment 56 may be made and acted upon. Other persons having had exposure to the primary exposure candidate may be tested for infection 58. If the results of the test are negative then no further steps may be taken and the logic flow may end 52a. However, if the results of the test are positive then a decision may be made and acted upon to isolate the tested person 62. A decision may be made and acted upon to clean all equipment exposed to the positive test person 64. Additionally, steps may be taken to identify new primary, secondary exposure cases 66. When such cases are identified a review as to whether a primary exposure may be made 50b. Should the case be a primary exposure the same steps as just recited may be undertaken.

Should the case not be a primary exposure, a review as to whether the case is a secondary exposure 50a may occur. It may be possible for the logic flow to begin with a review as to whether secondary exposure is evident 50a. Should the case not be a secondary exposure the logic flow may end 52a. However, if the case is identified as a secondary exposure the person's history, condition and other details, may reviewed to determine if the person is a high risk 68. If the person is deemed a high risk then a decision may be made and acted upon to isolate the person 54 and the logic path described above as following from this decision 54 may be followed.

However, if the person is not deemed to be a high risk then a review for evident symptoms 50d may occur. It may be possible for the logic flow to begin with a review for evident symptoms 50d. If there are no evident symptoms then the logic flow may end 52b. However, if symptoms are evident then a decision may be made and acted upon to isolate the person 54 and the logic path described above as following from this decision 54 may be followed.

A logic flow may begin with a review as to whether a person is high risk 50c. If the person is not deemed to be high risk a review as to whether symptoms are evident 50d may occur. If there are no evident symptoms then the logic flow may end 52b. However, if symptoms are evident then a decision may be made and acted upon to isolate the person 54 and the logic path described above as following from this decision 54 may be followed. Alternatively, if due to a review as to whether a person is high risk 50c a person is deemed to be high risk, a review as to whether primary exposure 68 has occurred may take place. If an instance of primary exposure is found a decision may be made and acted upon to isolate the person 54 and the logic path described above as following from this decision 54 may be followed. Or, if it is not a primary exposure, a review as to whether the case is a secondary exposure 70 may occur. Should the case not be a secondary exposure the logic flow may end 52b. However, if the case is identified as a secondary exposure a decision may be made and acted upon to isolate and monitor the person 72. Following this decision a person may be reviewed for evident symptoms of infection 50d and the logic path described above as following from this decision 50d may be followed.

A skilled reader will recognize that the infection control logic flow as shown in FIG. 5 is but one example of possible logic flows to be included in the invention. Other infection control logic flows may be utilized, as may be other types of logic flows. The logic flows may generally aid in decision making in response to particular situations occurring within a Geographical Area. The logic flows may reflect policies, guidelines, best practices, regulations, rules, operations, management or other standards relating to a Geographical Area. Additionally, the logic flows may be amended or removed as necessary to improve the effectiveness of the results of such logic flows to attain goals such as infection control. In this manner the logic flows may lead to an analysis of existing policies and amendments thereto.

The present invention may include several elements to facilitate disease mapping and infection control. In one embodiment of the present invention such elements may include a Business Intelligence Layer and a Mapping System. These can function on a variety of levels, including within an Institution or within a Geographical Area. A visual representation of such a level may be provided by the present invention, for example, such as by way of a map view, which may be static or show activity over a period time. The visual representation may further function to allow a user collapse and expand the visual representation to view a variety of levels. For example, the present invention may allow a user to zoom in on a specific Institution, or other point of reference, within a Geographical Area, as well as to expand the visual representation to view the area surrounding the point of reference. Utilizing the elements of the present invention a user may be able to watch a visual representation of the outbreak of an infection as it occurred in the past, to monitor infection spread in real time (or near real time), or to predict the outbreak and/or spread of an infection. The visual representation may follow an Entity as it moves through a Geographical Area, or facility, including movement between floors of a facility. The visual representation may be represented in 2D or 3D. The data of the system may also be provided in a variety of other formats, for example, such as in text form or graph form. A skilled reader will recognize that many other formats may be applied to the visual representation or other deliveries of the system data.

In one embodiment of the present invention, within the Business Intelligence Layer several additional tools may be incorporated. For example, these can include an asset management tool, a performance analysis tool and an infection control tool. These tools may be configured to function in combination with each other.

An embodiment of the present invention may integrate elements so that the Business Intelligence Layer collects data from one or more sources. This collection of data is facilitated by the Entity Management Tool which may incorporate an asset tracking means, such as an RTLS, whereby the movements of Entities are recorded. The collected data may be analyzed to produce risk output by the Performance Analysis Tool. The risk output may be displayed as a visual representation by the Infection Control Tool. If a Mapping System is integrated into the present invention the specific visual representation may be as a map showing infection hotspots and the spread of infection during a time lapse or in real time.

In an embodiment of the present invention, involving an Institution, for example, such as a hospital, the system and method may function so as to track a patient's profile and movement as well as any Intersections throughout the hospital between any Entities. Such Intersection may be occasions when infection or disease may be spread. In one embodiment of the present invention, tracking may occur and be represented visually to a user in real time. A skilled reader will recognize that other embodiments of the present invention may incorporate other Institutions or Geographical Areas, and apply tracking of Intersections therein.

A skilled reader will recognize that embodiments of the present invention may incorporate different configurations of tools and modules, in accordance with the intended application of an embodiment of the present invention. Additionally, in embodiments of the present invention some tools may function in a stand alone manner. Some of the tools that may be included in the present invention are discussed in more detail below.

### 1. Business Intelligence Layer

The Business Intelligence Layer of the present invention may undertake several functions including: collecting and incorporating new information, providing analysis and reporting based on prior information (this information may then be stored and used in the future), and allowing for the entry of data by a user (e.g. parameters entered for a known disease). The data of the Business Intelligence Layer can be analyzed by the system so as to identify infection hotspot sites and potential infection hotspot sites. The system may further provide actionable information based upon its analysis of the data. In embodiments of the present invention, access to the Business Intelligence Layer may be provided at a specific location, or by way of the Internet. A skilled reader will recognize that data collected by the Business Intelligence Layer may be of many forms depending upon the embodiment and application of the present invention, for example, such as patient details, disease information, asset information, physical layout, staffing levels or other relevant information.

There are a number of elements of the present invention that may be applied to feed information and function into the Business Intelligence Layer. In an embodiment of the present invention, these elements may include: an Entity Management Tool; a Performance Analysis Tool; and an Infection Control Tool. All of these elements may use common software code bits and may further be are able to share information.

### A. Entity Management Tool

One embodiment of the present invention, may include an Entity Management Tool. The Entity Management Tool may facilitate real-time mapping as it tracks Entities as they move in real time. This may be facilitated through the use of a RTLS system that features tags which emit signals at regular intervals that may be picked up by the network. The system may be configured so that information regarding Entities, such as patients, may be linked to the Entity being tracked (e.g. patient chart information from the database of an Institution may be associated with the patient in a particular room and marked with a RTLS tag). Such linking may or may not occur in real time. Mapping of tracking data related to an Entity may occur in either real time or not real time.

To produce the visual representation of the movement as a map of the tracked Entity, the Entity Management Tool may function in conjunction with the Mapping System. Such maps may show the spread of infection over time and/or the movement of Entities. Either 2D, 3D or other forms of mapping techniques may be applied to such maps and they may be presented so that a viewer can virtually travel around an Institution or Geographical Area (e.g. look around a hospital).

The Entity Management Tool may facilitate a calculation of risk exposures for Entities. Risk factors incorporated in such calculations may include several factors, for example, such as: details regarding an Entity; the location of Entities; movement of Entities; intersection of entities and environmental issues, for example, such as occupancy levels. A skilled reader will recognize that other factors may be incorporated into the risk calculations. In one embodiment of the present invention, the Entity Management Tool may weight outbreak scenarios separately and then combine the scenarios to develop a Total Risk Index Score that may range from 1 to 100. As more data is gathered regarding various Entities and the spatial intersections of these Entities, a deeper understanding of the links between Entities may be developed. This may offer further data to be utilized for scenario weighting purposes and to produce a more robust Total Risk Index Score. The Total Risk Index Score may be used to inform two main functions of the present invention: (i) to model enterprise exposure with ability to drill down geographically via a decision support dashboard; and (ii) to guide infection control through operational management and response.

The Entity Management Tool may be configured to function in compliance with legislated reporting and monitoring requirements.

### B. Performance Analysis Tool

One embodiment of the present invention may incorporate a Performance Analysis Tool that is able to review data regarding infection outbreaks for the purpose of deriving an analysis thereof. It may be possible to integrate parameters introduced by a user into the performance analysis tool. For example, a user may introduce parameters relating to an infection or disease that is expected to reach a particular Geographical Area or Institution. Alternatively, a user may introduce parameters that represent particular policies or procedures for response to an infection or disease outbreak to model and test the effect of such parameters. The Performance Analysis Tool may produce a variety of output analysis, for example, such as output that addresses questions regarding how to arrive at a better and/or faster operational response to an outbreak (e.g., a previous outbreak, a current outbreak, or a predicted future outbreak). Additionally, the Performance Analysis Tool may consider outbreak transmission identified through an analysis of the tracking data collected by the Entity Management Tool. The Performance Analysis Tool may also analyze risk factors created due to the location, movement and spatial Intersections of any Entity. An output of the Performance Analysis Tool may further include the production or setting of metrics. Additionally, these metrics could be tracked over time to establish or support a performance improvement framework and/or peer comparison within an institution, across institutions or Geographic Area. A skilled reader will recognize that the Performance Analysis Tool may provide output that has financial implications for an Institution or Geographical Area.

In one embodiment of the present invention, the Performance Analysis Tool may function in conjunction with the Mapping System to provide a visual representation of the analysis in the form of a map to be viewed by a user. The may map generated may apply particular colour coding or other means of representation to show activity (e.g. colour coding for specific concerns or after the fact occurrences, such as where people met with others and transferred infection).

### C. Infection Control Tool

One embodiment of the present invention may include an Infection Control Tool. The Infection Control Tool may be used in several manners: within an Institution; as a syndromic surveillance tool; or to provide a pathogenic, outbreak, or pandemic simulation.

An application the Infection Control Tool within an Institution may cause it to function in conjunction with an Entity Management Tool and a Mapping System, to model and display the transmission of an infection or disease throughout an Institution or Geographical Area. The Entity Management Tool may be utilized to provide data relevant to Entities and how they intersect either in real-time or historically. The Mapping System may enable a user to view the movements and Intersections of Entities within the Institution or Geographical Area in 2D, 3D or other forms of views.

The model and display of the Infection Control Tool may include the transmission of an infection or disease as it has spread within the Institution in the past, or it may reflect the possible spread of a future infection or disease within the Institution. Logic applied by the Infection Control Tool in its application within an Institution may follow the flow of FIG. 5, although a skilled reader will understand that other data flows may be applied by the present invention.

To apply the Infection Control Tool to the dissemination of a future infection or disease a user may be permitted to input parameters relating to a specific infection, or other data. A skilled reader will recognize that other data may also be entered into the system, for example, such as data from another Institution that experienced an outbreak of infection or disease. As shown in FIG. 1 one form of inputted data may be that related to proposed infection control best practices or procedures and the output of the Intelligent Control Tool may affect the development of infection control policies and operational responses. All of the data provided may be utilized by the system to provide a representation of the dissemination of an infection within an Institution.

Another embodiment of the present invention may be to apply the Infection Control Tool to the surrounding community as a syndromic surveillance tool. For this purpose one or more databases of the system may be linked to a service component which is capable of linking to an external database, for example, such as one or more hospital databases. Through this connection information may flow between the system database and other databases by way of the service component. The database connection allows for the collection of additional data that may be applied by the Infection Control Tool to represent the Intersections of Entities within a Geographical Area. For example, in one embodiment of the present invention the collection of this data for various sources within a Geographical Area may allow the system to track the spread of infection within a community. In such an embodiment the service component may be linked with one or more public health unit databases and/or with live data from the emergency departments of one or more hospitals. The Intersection of Entities may therefore be represented visually in the form of a map.

Depending upon the data sources available to the present invention, through a database link-up to the system, the Infection Control Tool may utilize a variety of information sources to track community Entities. For example, the Infection Control Tool may use the postal code of patients to provide base information and then model and display as a map the rate of infection of patients from the same postal code using the Mapping System in association with a GIS. The Infection Control Tool may also be used in conjunction with the Mapping System to show the Intersection between specific community members whereby an infection or disease may be spread. Additionally, a user may input parameters whereby data may be manipulated for the purpose of exploring alternative infection or disease spread, for example, such as, parameters pertaining to a particular disease, parameters pertaining to a location or other parameters. A skilled reader will recognize the various means of collecting data, modeling data and displaying data that may be applied in the present system to display infection or disease dissemination and rates.

Yet another embodiment of the present invention may apply the Infection Control Tool to pathogenic, outbreak or pandemic simulations. In this embodiment the Geographical Area may be wide to show the spread of infection or disease in and between regions, countries and/or continents. The model may include historical, real time or projected data. In some embodiments of the present invention, the data may include parameters inputted by a user, or data collected from an external source. This data may be of the type utilized for the Institution and syndromic surveillance embodiments discussed above. Moreover, it may be received directly as a database to database transfer undertaken through a service component, as described above. Through use of the Mapping System it may be possible to simulate a pathogenic, outbreak or pandemic spread on a map in a manner that shows activity relating to the pandemic over time. For example, the activity may include the Intersection of persons, communities or other Entities whereby infection or disease is disseminated, the rate of infection in particular regions, or the spread of infection or disease within regions and areas and the eventual convergence of infected regions and areas with other infected regions or areas.

A skilled reader will recognize that the means of modelling and displaying a pathogenic spread, outbreak or pandemic may be varied. A skilled reader will additionally recognize that the information gathered for this purpose may be of many types and derived from many sources. A skilled reader will further recognize that the Infection Control Tool may be utilized to predict the effect of the pandemic on schools and hospitals in the surrounding communities. The Infection Control Tool may also be used to get ahead of spread and for morbidity and mortality calculations, as well as for other applications and outputs.

### 2. Mapping System

One embodiment of the present invention may include a Mapping System. The Mapping System may enable a user to view the data collected by the Business Intelligence Layer or from external sources, or a combination of these, in the form of a map. For example, such a map may show the movements and Intersections of Entities. Other possible information and activities that may be displayed upon the map are discussed above and a skilled reader will realize that the visual representation of the data of the Business Intelligence Layer may be displayed in many forms and that these are not limited to those discussed in this application.

The Mapping System may facilitate the display of Business Intelligence Layer data in the form of a map showing the data in real-time, historically or as a prediction. The map may be displayed as 2D, 3D or other form. The Mapping System may generate a map that allows a user to move through the space in a manner that allows for view of multiple floors in an Institution, and can expand or limit the viewing area in a manner that involves a zoom-in or zoom-out function. For example, in an embodiment of the invention it may be possible for a view of the map to view an individual located within an Institution and then zoom-out so as to relate the location of the individual to locations outside the facility in the surrounding community. In this manner it is possible to move seamlessly from an Institution view through syndromic surveillance and/or pandemic-level spread.

### Examples of Modules of Present Invention

The present invention may have several applications and these may include various modules. The following are examples of possible modules that may be included in the present invention to generate particular determinations, analysis, output and/or communications. A skilled reader will recognize that the present invention is not limited by any of the presented examples, a variety of modules for infection control may be incorporated in the present invention.

### Handwashing Compliance Module

One embodiment of the present invention may include a handwashing compliance module. This embodiment may be automated and facilitate the tracking of handwashing compliance within a Geographical Area, such as an Institution. The tracking may occur in real time or near real time. Based upon the tracking information reports, alerts or other communications may be produced regarding handwashing occurrences involving Entities within the Institution. Such reports, alerts or other communications may further provide output regarding whether handwashing occurrences are in compliance with any policies or procedures of the Institution. Additionally, the reports, alerts or other communications may be utilized to generate new policies or procedures relating to handwashing within an Institution.

Handwashing behaviour can have a significant effect upon public health. For example, handwashing by staff members within a hospital can reduce hospital-acquired infections by decreasing the number of pathogens on the hands of the staff members. Decreased pathogens can mean that fewer pathogens are transferred when staff members intersect with other Entities, such as patients and/or equipment, and consequently fewer hospital-acquired infections may occur due to transfer. Handwashing is identified by experts as the most important and least expensive measure for preventing the transmission of hospital-acquired infections. Research reports to-date indicate that handwashing compliance rarely exceeds 40%, even in intensive care units within a hospital. Research further reports that approximately one third of medical professionals surveyed knew that cleaning hands with soap and water was essential in preventing the spread of hospital-acquired infections. The handwashing compliance module, as part of the system for disease surveillance, mapping and infection control of the present invention, may influence handwashing practices and thereby increase the effectiveness and rate of handwashing by Entities within a Geographical Area.

The handwashing compliance module may utilize the RTLS tags attached to Entities. The module may further utilize a map of the Geographical Area, such as a floor plan of an Institution which may be a digitized floor plan. The movements, contact and intersections occurring amongst Entities within the Institution may be tracked utilizing the RTLS tags. In particular the module may monitor the location and time spent by Entities in relation to handwashing locations.

For example, the module may monitor the location and time spent by staff members in relation to handwashing locations versus patient proximity.

For example, an embodiment of the present invention may incorporate a handwashing compliance module that facilitates handwashing monitoring and reporting within an Institution that is a hospital, and includes dedicated monitoring hardware receivers focused on handwashing stations within a clinical patient or staff area of the hospital. The RTLS tags worn by, or otherwise attached to, staff members may register when a staff member is within a defined area proximate to a handwashing station. For example, a RTLS tag worn by a staff member may register if the staff member is directly in front of, or beside, a handwashing station. The handwashing compliance module will measure the time the staff member spends in this area. Once the staff member moves away from the handwashing station the measured time interval may be analysed by the system and compared to handwashing guidelines, such as handwashing policies that staff members are required to comply with, which may include infection control best practices regarding the appropriate time that clinical staff members, other staff members, or other individuals should be washing their hands before coming into contact with a patient.

The proximity of the staff member to a handwashing station and the measured time interval may further be identified by the system and the handwashing compliance module as a “handwashing event”. The handwashing event may be categorized as compliant or non-compliant, based upon the results of the comparison of the measured time interval of the handwashing event to handwashing guidelines. A compliant handwashing event may last for a time interval that is as long as or longer than the time interval stated in handwashing guidelines for effective handwashing. A non-compliant handwashing event may last for a time interval that is shorter than the time interval stated in handwashing guidelines and therefore may be deemed to represent ineffective handwashing.

The handwashing compliance module may also monitor the subsequent movement and location within the hospital of a staff member having a non-compliant handwashing event. In particular, the monitoring may recognize Intersection with a patient within a defined period of time. If a staff member comes into contact with a patient without first registering a compliant handwashing event an alert may be generated by the handwashing compliance module. The alert may be automatically generated. The alert may be transferred to any data storage means, or communicated to any device capable of displaying or otherwise indicating an alert, or any other element of the system for disease surveillance, mapping and infection control of the present invention.

The system of the present invention may further be capable of categorizing Intersection of staff and patients as events that are handwashing compliant or handwashing non-compliant. The system may additionally be capable of tracking, determining and reporting rates of handwashing compliant or handwashing non-compliant Intersections between staff and patients. Such tracking, determining and reporting of such rates may be stored to one or more databases as data and may be communicated to hospital staff and/or hospital mangers by way of reports or other communications.

The benefit of the system of the present invention including the handwashing compliance module over the prior art is that prior art does not have a means of tracking compliant handwashing events or non-compliant handwashing events in a non-evasive manner. Prior art consists of observation studies in clinical settings where an obvious, visible clerk records incidences of handwashing behaviour. The capability of the present invention to track compliant handwashing events and non-compliant handwashing events in an unobtrusive manner may facilitate more accurate recording of handwashing events. The Entity engaged in a handwashing event is less likely to act in a manner that is affected by the knowledge of observation and he or she is therefore more likely to act in a natural manner during a handwashing event. Moreover, the Entity is likely to engage in handwashing at a rate that is not affected by the fact that the Entity knows someone is observing its handwashing practices. Thus, the registration of handwashing events is more likely to reflect normal every-day handwashing practices of an Entity than the prior art. The tracking, monitoring, measuring, reporting, and any other aspects of the handwashing compliance module may be automated and continuous.

The collection of data that reflects normal every-day practice and the application of this data in analysis, determinations and outputs may lead to the creation of more effective handwashing guidelines, policies, or practices. Additionally, continuous tracking facilitated by the handwashing compliance module may reflect whether any habitual change occurs as a result of any handwashing guidelines, policies or practices. The data generated by the handwashing compliance module may further indicate any lasting impact of such handwashing guidelines, policies, practices or other influences on handwashing events and the rate of handwashing. Through analysis of the handwashing data it may be possible to find a trigger to facilitate increases in compliant handwashing events as well as permanent and habitual compliant handwashing events by staff members generally.

As an additional benefit, as handwashing can a simple, effective precaution, the handwashing compliance module may aid in directing attention to this measure of eradicating non-compliant handwashing events and increasing the rate of handwashing generally. Prior art methods of monitoring handwashing compliance can be time-consuming and labour-intensive. For example, either a person is required to watch handwashing as it occurs live, or if a camera is positioned at a handwashing station, then a person must watch the footage of the film to view each handwashing event. By integrating the handwashing compliance module with the system of the present invention it is possible for hospitals to streamline their approach to diminish the transfer of hospital-acquired infections.

A skilled reader will recognize that the example presented of the handwashing compliance module references its application in a hospital to monitor handwashing by staff members. However, the handwashing compliance module may be utilized as part of the system of the present invention in a variety of Geographical Areas to monitor, track and generate data regarding handwashing by any Entity and the intersection of that Entity with other entities. The handwashing compliance module may provide a means of tracking the spread of infection within a Geographical Area.

### Pathogenic Reservoir Location Determination Module

Another embodiment of the present invention may include a pathogenic reservoir location determination module. Such a pathogenic reservoir location determination module may be automated. The pathogenic reservoir location determination module may further perform in real-time or near real-time.

The pathogenic reservoir location determination module may facilitate the identification of locations within a Geographical Area such as an Institution where significant levels of pathogens or particular types of pathogens exist. Areas where significant levels of pathogens exist may be identified as pathogenic reservoirs. The identification of pathogenic reservoirs may occur due to an analysis of historical-temporal movement and location patterns of infected Entities. Such analysis may determine one or more locations where infections originate.

Each Entity may have a RTLS tag attached to it. The Entity may move within a Geographical Area. Intersection between Entities may be registered by way of the RTLS and this data may be stored in a storage means, such as a database located either internal or external to the Geographical Area.

The pathogenic reservoir location determination module may facilitate the recognition of locations within a Geographical Area, such as a hospital or clinical setting, where a pattern of instances of infection of Entities occurs. An infection occurrence may be identified when an Entity is determined to be “negative” for infection prior to entering an area and is determined to be “positive” upon leaving the area. An determination of “negative” or “positive” status may be accomplished through an analysis involving the date and time of an Entity's positive test for an infectious pathogen. Previous Intersections with other Entities that also tested positive for the same infectious pathogen or same pathogen strain may be plotted by the system.

Intersections between Entities are significant as such Intersections may represent transfer of the infections pathogens between Entities. Intersections may include person-to-person contact, contact between a person and equipment, or other types of Intersections between Entities whereby pathogens may be transferred. The types of intersections that will be relevant may be determined by the type of pathogen (e.g., the means whereby this type of pathogen may be transferred, and any time-limits during which the pathogen may survive upon an Entity pre-transfer). A skilled reader will recognize that other pathogen related considerations may be included in the analysis of Intersections between Entities for the purpose of identifying an infectious reservoir within a Geographical Area.

One or more infectious reservoirs may be identified through plotting the Intersections of Entities within a Geographical Area. For example, an infectious reservoir within a hospital may be a sink drain, cracked floor, air-duct, or other similar location.

The pathogenic reservoir location determination module of the present invention offers benefits over the prior art because it is a targeted approach to identifying an infectious reservoir. Prior art methods generally involve clinical staff members attempting to narrow down the possible locations of infectious reservoirs through anecdotal interviews, best guesses and conventional practices. The outcome may be that rather than identifying a localized infectious reservoir, a determination that the whole of an Institution be cleaned. This can lead to increased labour and cost.

The pathogenic reservoir location determination module of the present invention may provide a method of targeting infectious reservoirs based on systematic, spatial-temporal measurements of disease acquisition.

### Milestones Module

Yet another embodiment of the present invention may include a milestones module. The milestones module may be automated. The milestones module may generate milestones in relation to elements relevant to a Geographical Area. For example, in a healthcare facility, such as a hospital or clinical setting, milestones may be related to best practices, policies, operations, and management. A skilled reader will recognize that milestones may be related to a variety of other elements and that relevant milestones may be chosen in accordance with a particular Geographical Area.

The milestones module of the present invention may utilize RTLS tags attached to Entities within a Geographical Area to calculate movement of Entities and Intersections of Entities. For example, if the milestones module is utilized for a hospital then RTLS tags may be attached to patients, staff members and hospital assets, such as equipment. A digitized floor plan of the hospital, or any hospital wing, or hospital floor, may be incorporated in the system. The RTLS tags may be utilized to track the movement of patients, staff members and hospital assets, as well as the intersections occurring amongst patients, staff members and hospital assets. The milestones module may be operable to analyze the tracking data and thereby interpret the location of any patient, staff member or hospital asset, within the digitized floor plan and to show this in real time or near real time. The milestones module may further be operable to analyze and interpret certain activities of patients, staff members or hospital assets. To facilitate such interpretations the present invention may apply logic based algorithms to identify interpreted activities or locations of patients, staff members or hospital assets based on tracked location, Intersection and duration. The interpreted activities or locations may be recognized as milestones. For example, within a hospital, such milestones may represent either clinical or operational milestones.

A user may define one or more milestones in the milestones module. A milestone may indicate a variety of events within a Geographical Area, for example, such as one or more Intersections of Entities, aspects of operation of an Institution, or facets of health care. A milestone in a hospital setting for example may be an event such as a patient bed assignment. A definition for a patient bed assignment may be the event occurring when a patient is assigned to an available bed within an Institution, such as a hospital or clinical care setting. The milestone of a patient bed assignment can provide data relevant to several aspects of the operation of an Institution and/or patient care. A patient bed assignment milestone may provide data from which an understanding of any of the following may be ascertained: wait-times for care delivery; patient access to care within a hospital of clinical care setting; monitoring of availability of beds (which may occur on a real-time or near real-time basis); and/or operational flow. These are merely examples of the types of data that may be ascertained from a particular milestone, a skilled reader will recognize that a variety of other types of data may be ascertained from a particular milestone.

A milestone event may be recognized through an analysis of RTLS tag data. The event may be coded by the software and stored in a storage medium, and/or communicated immediately to a user. For example, a patient bed assignment milestone may be recognized as occurring when a patient is in the same location as an “available” bed for a specified period of time. An “available” bed may be identified as a bed that is not occupied by, or assigned to, another patient or person. When a bed assignment milestone occurs the milestone module may recognize that a particular patient is assigned to a specific available bed which the patient is in the same location of for a particular period of time, as defined in the patient bed assignment milestone, and the date and time when the bed assignment occurs. This data may be stored to one or more databases.

Another example of a milestone may be a physician assignment. A physician assignment milestone may be recognized by the milestone module as an event that occurs when a care provider or physician intersects with a patient in a clinical setting for a set period of time. The set period of time may be consistent with an amount of time that is an expected time for clinical interaction. Such a set period of time may be determined and defined in the physician assignment milestone by a system administrator or other authorized user. The set period of time and other aspects of the milestone may further reflect hospital or clinical setting policies, guidelines or other regulations regarding standards of care. Upon the occurrence of a physician intersecting with a patient as defined in the physician assignment milestone, the milestone module may recognize that particular physician as assigned to the patient with whom the Intersection occurs. The assigned physician may be assumed to be in charge of the care of that patient. It may be possible for multiple physicians to be assigned to a single patient. The collected data may be stored to one or more databases.

The embodiment of the present invention that includes the milestone module may be operable to facilitate analysis and reporting regarding wait-times for care delivery and patient access to a health professional based upon the patient bed assignment and physician assignment milestones. For example the length of time between a patient bed assignment milestone and a physician assignment milestone may provide a performance and/or policy metric that describes how long a patient is waiting to be attended to by a physician. The milestone module of the present invention may also be operable to monitor the operational flow of physicians and thereby may facilitate a determination of the rate of patient interaction with one or more physicians over a period of time, or the time a physician spends with a patient. Additionally, the milestone module of the present invention may be operable to determine performance and operational metrics, such as the average time spent with patients based on the clinical symptoms or diagnosis of the patient. A skilled reader will recognize that a variety of performance and operational metrics may be determined by the present invention utilizing, at least in part, data generated by the milestone module. Other data collected from other data sources may also be utilized.

The milestone module of the present invention may be operable to monitor, analyze, and report on the implementation of policies, guidelines, best practices, regulations, rules or other standards applicable to a Geographical Area, for example a hospital. Such monitoring may occur in real-time or near real-time. For example, the monitoring may generate analysis or report on the number of bed transfers that occur in the hospital. The result of this monitoring may be a policy that imposes a limitation on the number of bed transfers occurring to comply with a best practice for hospital infection control. It may be possible for the present invention to produce alerts of possible violations of hospital policies or other standards. Such alerts may provide localized information relating to the specific time and place of the infraction. The alerts may be generated and/or communicated based on real-time monitoring and therefore may produce a basis for immediate action in response to the infraction.

A skilled reader will recognize that the milestones module may be configured to recognize a variety of milestone events. Such milestone events may be any event having a spatial-temporal component that is determinable through the RTLS and/or GIS systems. Additionally, milestone events and spatial-temporal components of activities occurring prior to and after the milestone events may be monitored and details of such activities may be captured and stored in a data storage means.

The following are examples of clinical milestone events that may be included in a milestones module to be utilized in a hospital or health care facility.

A patient arrival milestone event may be registered by the present invention when a patient is assigned an RTLS tag and the assignment is registered in the system.

A discharge assignment milestone may be registered when a patient is unassigned a RTLS tag.

A bed status occupied milestone may be registered when a patient has been in same location as a bed having the status “available” for a specified period of time. Alternatively, a bed status occupied milestone may be registered when an Entity activates an occupied button on the bed to activate the RTLS tag attached to the bed.

A bed status cleaning required milestone may be registered when a patient has been assigned a different location from the bed previously assigned to the patient for a specified period of time. Alternatively a bed status cleaning required milestone may be registered if the RTLS tag of the patient associated with the occupied bed is unassigned. Yet another alternative for a bed status cleaning required milestone to be registered is when the cleaning button of a RTLS tag attached to a bed is activated by an Entity.

A bed status available (clean) milestone may be registered when an assigned button on the RTLS tag attached to a bed is activated.

A specimen tracking milestone may be registered when a specimen is collected from a patient. Additionally, more specific specimen tracking milestones may be registered while the specimen is monitored after the collection and up until the laboratory results related to the specimen are reported.

Other milestone events may be included in a milestones module, as required for particular applications of the present invention and to reflect the activities occurring in a particular Geographical Area.

Additionally, a wide range of data, reports, metrics and/or alerts may be generated based on a determination of the events. For example, such as a determination of the time between milestone events. Such data, reports, metrics and/or alerts may be stored in a storage medium and may be communicated by the milestone module of the present invention, or other communication element of the system of the present invention, either immediately or at a later time.

The milestones module of the present invention provides particular benefits over the prior art. The methods of data collection and entry of prior art consists of a patchwork of manual data entry and irregular observation studies, such as those occurring in clinical settings. The capture of milestone events through manual entry may be subject to human error. Details of the event may be omitted and the entry of the milestone event information may not be completed in real-time or even near real-time. Additionally, the location of the milestone event may not be captured and/or recorded. In order to capture a new clinical milestone event it may be necessary in prior art methods to introduce new systems and/or processes. The present invention may provide a benefit over the prior art in that the monitoring, analysis, communication and/or alerts may be operable to collect significant data relating to details of a milestone event. The data collection may be automatic therefore manual entry may not be required. Additionally, the monitoring and collection of data may occur in a persistent, continuous manner. The collection of data and the communication of detailed output may occur in real-time or near to real-time. It is possible that the use of the milestones module of the present invention may lead to consistent, habitual improvements in practices in a Geographical Area, such as institutional and/or operational practices. The regular monitoring of milestone events, the data relating to these events, and the data determined utilizing the event data, may be reviewed by persons, such as staff and/or management, to develop and update best practices. The result may be a process of continuous improvement.

Alert and/or Action Module

Another embodiment of the present invention may include an alert and/or action module. The alert and/or action module may be automated. The alert and/or action module may generate one or more alerts that may communicate the requirement for particular actions as based upon and related to policies, guidelines, best practices, regulations, rules, operations, management or other standards within a Geographical Area. Any event or series of events that are deemed to be important, and therefore represent an occasion of note, may generate an alert communication and/or one or more action communications. The occasion of note may be determined by way of the RTLS or GIS system of the present invention and based on logic that uses a temporal, spatial component.

The present invention may utilize RTLS tags attached to Entities within a Geographical Area and a digitized map of the Geographical Area to calculate the movements, contact and intersections of Entities within the Geographical Area or any portion thereof. For example, if the Geographical Area is defined to be a hospital, movements, contact and intersections between Entities may be calculated within the entire hospital building and grounds, a hospital wing, a hospital floor, the hospital building, or any other portion of the hospital grounds and building. The present invention may be operable to monitor and interpret the locations of Entities and certain activities of Entities within the specified Geographical Area or specified portion of the Geographical Area. The present invention may utilize logic-based algorithms to interpret the locations and activities of the Entities and may utilized information from other systems exterior to the specified Geographical Area or specified portion of the Geographical Area in such interpretations. The interpretations may generate alerts and/or actions based on the location of Entities, intersection of Entities, or the time or duration of the location or intersection of Entities. In particular, the present invention may generate alerts and/or actions based on the location of Entities, intersection of Entities, or the time or duration of the location or intersection of Entities that does not comply with policies, guidelines, best practices, regulations, rules, operations, management or other standards applicable to a Geographical Area.

As an example, an alert may comprise a message generated when an Entity who is a patient is moved between Entities that are two or more beds more frequently than the frequency suggested by a best practice for infection control. The alert message may be communicated by the present invention to one or more users of the present invention, such as, for example, a manager or director of the Geographical Area. Upon receipt of the alert message one or more actions may be required, and one or more action messages may be communicated to the relevant parties required to perform such actions. For example, an Entity who is a staff member working in the Geographical Area may be required to test the patient for nosocomial infection. Additional actions may also be required, such as a review of procedures to reduce future occurrences of the movement of a patient between beds more frequently than the frequency suggested by a best practice for infection control. A skilled reader will recognize that a wide variety of alerts and/or actions may be generated by the alert and/or action module of the present invention.

The alert and/or action module may produce alerts in response to the location of Entities, intersection of Entities, or the time or duration of the location or intersection of Entities that does not comply with policies, guidelines, best practices, regulations, rules, operations, management or other standards applicable to a Geographical Area in real-time or near real-time. In particular, the location of Entities, intersection of Entities, or the time or duration of the location or intersection of Entities that does not comply with policies, guidelines, best practices, regulations, rules, operations, management or other standards applicable to a Geographical Area that pose risk for one or more Entities, or a Geographical Area generally, may produce alerts in real-time. The alert may require one or more particular actions. The actions may include an immediate response to either address the risk or thwart further risk.

For example, the location of an Entity who tests positive for an infectious disease may cause an alert to be generated that requires an immediate response of designating an area where the Entity is located as quarantined. Associated messages, alerts and actions may also be generated following the initial alert to require the quarantined area to be cleaned and/or to test any at-risk patients. At-risk patients may include for example, other patients who the Entity that tested positive came into contact with, other patients in the vicinity of the location of the Entity that tested positive, or patients deemed to be at-risk of infection for other reasons.

The alert message and the one or more action messages related to that alert may be communicated to the same parties, or to different parties. For example, the alert may be communicated within a hospital to the hospital director and all staff members, whereas the one or more action messages may be communicated to the one or more staff members required to undertake the one or more required actions. In some instances only an alert message may be sent without any action message. Alternatively, if an action message is communicated following and related to an alert message, a single action message may be communicated that indicates one or more actions. It is also possible that an alert communication may also include details of one or more required actions related thereto.

The alert and/or action module of the present invention may provide a benefit over the prior art in that it communicates to the appropriate persons an occasion of note and may additionally notify the appropriate persons of required actions to respond to the occasion of note. Alert and action communications, in isolation or combination, may increase the recognition of an occasion of note. Action communications in particular may further increase the rate of a response to an occasion of note as well as the effectiveness of the response by providing specific communication regarding the required response. Additionally, the alert and action communications may provide ongoing monitoring and reporting of occasions of note, the required response and the response thereto and bring these to the attention of the appropriate parties who require notice of such details. The alert and action communications may be generated automatically, may be communicated to multiple parties instantaneously, and may also be generated in real-time or near real-time. Prior art methods require that alerts be communicated in a non-automatic manner, often by way of user initiation. Prior art methods further communicate alerts or actions in a non-simultaneous manner and in accordance with a chain of command or hierarchical organizational chart. This delays the communication of alerts or actions from the time of the occasion of note and thereby creates a lag in the response by appropriate parties.

Additionally, prior art consists of a patchwork of manual and reactive responses to occasions of note as they develop, without any consideration of real-time location information. The real-time location information provided by the present invention can improve action response performance. Prior art systems further require the introduction of protocols and staff time to capture new mandated clinical alerts or clinical actions. The present invention facilitates automated and continuous monitoring, measuring and reporting whereby occasions of note may be identified and alerts and/or actions may be communicated. The present invention is operable to easily extend to include additional alerts or actions, for example, such as new mandated clinical alerts or clinical actions.

A skilled reader will recognize that a variety of alert and action communications may be facilitated by the alert and/or action module of the present invention. The following are examples of such alerts and/or actions that may be communicated by the present invention if it is utilized in a hospital or health care facility.

An occasion of note may be recognized if a commode appears in proximity to more than one patient in succession without first appearing in proximity to sanitizing equipment. Upon recognition of this occasion of note an alert may be communicated to a nursing supervisor, cleaning supervisor and infection control supervisor indicating that a best practice violation has occurred that poses a risk. Additionally an action may be communicated to one or more cleaning staff members requiring that the commode be sanitized prior to any further use.

An occasion of note may be recognized if expensive equipment leaves the hospital. An alert may be communicated to the director of the hospital indicating that the equipment has left the premises of the hospital. Additionally, an action may be communicated to security staff to sound the alarm, which may be facilitated automatically by the present invention, or may be facilitated manually by a security staff member. The communicated action, or an additional action, may further be communicated to the security staff to indicate that a suspected theft may be in progress.

An occasion of note may be recognized if a patient located distant from a bed, has little or no movement for a specified period of time. An alert may be communicated to all clinical staff members and security staff members that a patient may have removed his or her RTLS tag.

An occasion of note may be recognized if a patient RTLS tag drops to floor level. An alert may be communicated to clinical staff members assigned to the patient. An action may be communicated to all clinical staff members as an emergency call for medical personnel of a suspected patient collapse.

An occasion of note may be recognized if a patient is located in a hallway upon a stretcher for a specified period of time, such as twenty-four hours, without any contact with a physician above a specified rate of contact. An alert may be sent to the hospital director and hospital chief of staff indicated a possible medical malpractice event.

Other alerts and/or actions may be included in an alert and/or action module, as required for particular applications of the present invention and to reflect the occasions of note occurring in a particular Geographical Area.

It will be appreciated by those skilled in the art that other variations of the embodiments described herein may also be practiced without departing from the scope of the invention. Other modifications are therefore possible. For example, the dissemination of consumer products or the paths of animals may also be tracked, analysed and represented visually.

We claim:

1. A method for disease vector transmission measurement and infection control characterized in that it comprises the steps of:
(a) utilizing an entity infection tracking system to track the movement, of one or more entities within a geographic area, said entity infection tracking system including a tracking means that utilizes one or more location-aware devices, said tracking means being operable to generate and transfer data pertaining to the one or more entities, as is recognized by the location-aware devices, to the tracking means that is linked to the entity infection tracking system and is operable to generate tracking data by at least one of the following further steps:
(i) utilizing the tracking means to track the one or more entities within a defined area and utilizing the tracking means data to produce or calculate entity tracking data;
(ii) recording locations and movement of the one or more entities within the geographic area;
(iii) recognizing direct contact and indirect contact between the one or more entities and storing this as contact data;
(b) transferring the tracking data to the entity infection tracking system and integrating the tracking data with additional data pertaining to infection or suspicion of infection of at least one of the one or more entities to generate potential infection data;
(c) ascertaining the risk of infection pertaining to one or more of the one or more entities by analyzing the risk of infection of the one or more entities with regards to direct or indirect interaction with the one or more entities that are identified as potentially infected entities to generate infection data;
(d) linking at least the tracking data, the potential infection data and the infection data and utilizing the linked data to analyze the potential spread of infection, and the risk of infection relating to the one or more entities as at least one of the following: entity infection status; entity risk of infection; entity location; entity direct or indirect contact or interaction with other of the one or more entities; and
(e) generating one or more communications or reports for at least one of the following: risk of infection; potential infection spread; or one or more potential sources of infection.

2. The method for disease vector transmission of claim 1, characterized in that it comprises the further steps of: identifying individuals, patients, equipment and assets within the geographic area as the one or more entities, said geographic area being at least one of the following: a hospital, a long term care centre, a medical clinic, a ship, or any other building or specified area.

3. The method for disease vector transmission of claim 1, characterized in that it comprises the further steps of:
(a) utilizing at least one of the following as additional data: one or more remote databases; one or more internal databases; or manual inputs by a user into the entity infection tracking system;
(b) utilizing at least one of the following to generate the analysis of risk of invention: the tracking data; the potential infection data; data from one or more remote databases; data from one or more internal databases; or manual data input by a user into the entity infection tracking system; and
(c) Tracking the movement, of entities (people, equipment and assets) inside a building or group of buildings, (such as a hospital, Long Term Care Centre, Medical Clinic, ship, or other type) using entity infection tracking devices (e.g. Real Time Location System (RTLS) such as Active Radio Frequency Identification (Active RFID), etc)

4. The method for disease vector transmission of claim 1, characterized in that it comprises the further steps of:
(a) the tracking means utilizing at least one of geometric coordinates or geographic coordinates, to track the one or more entities; and
(b) the tracking means recognizing direct or indirect contact between the one or more entities in real-time or near-real time and recognizing contact between the one or more entities over multiple degrees of contacts between the one or more entities.

5. The method for disease vector transmission of claim 1, characterized in that it comprises the further step of the entity infection tracking system processing data collected by the tracking means to indicate automatic and accurate contact tracing from the one or more entities identified as infected across a historical contact network, said historical contact network being defined by a period of time, and said automatic and accurate contact tracing involving at least one of the following steps:
(a) identifying the primary contact intersections between the one or more entities and calculating such intersections calculated from location coordinates of the one or more entities with an infected entity over a defined period of time;
(b) identifying the intersections of the one or more entities identified as one or more primary contact entities with other of the one or more entities identified as one or more secondary entities, and identifying the intersection of the one or more secondary entities with the one or more entities identified as tertiary entities, and continuing this process with expanding degrees of intersections between the one or more entities with one or more of the one or more entities identified as infected entities or suspected infected entities; and
(c) identifying one or more common locations within a defined area visited by the one or more entities identified as one or more infected or suspected infected entities, as indicated by the tracking data, and identifying any other of the one or more entities that were exposed within the one or more identified common locations.

6. The method for disease vector transmission of claim 5, characterized in that it comprises the further step of communicating the analysis of the entity infection tracking system to indicate at least one of the following: the location of the one or more potentially infected entities; or the one or more common locations, within a map of the geographic area, the defined area, or any other determined area so as to present a visual display of areas having at least one of the following:
(a) a risk of infection;
(b) a risk of infection spread; or
(c) a probable amount of infection contamination;
said communication showing the analysis in real-time, near real-time, as historical data or as a prediction based on the tracking of the one or more entities through the area of the communication

7. The method for disease vector transmission of claim 6, characterized in that it comprises the further step of linking to one or more entities in the communication to data of the entity infection tracking system so that an indication may be provided upon request by a user as to whether the one or more entities included in the communication have a status of: positively infected, exposed to infection, or other status.

8. The method for disease vector transmission of claim 5, characterized in that it comprises the further step of displaying the communication as one of the following: a hot zone mapping; or exposure locations mapping.

9. The method for disease vector transmission of claim 1, characterized in that it comprises the further step of utilizing a tracking of equipment and asset clean status means to collect data to be transferred to and processed by the location aware system to undertake at least one of the following steps:
(a) indicating that equipment and assets used in the delivery of care that are at least one of the one or more entities have been properly cleaned and decontaminated between each use, and generating a clean status for said equipment and assets;
(b) tracking the operational status of equipment and assets existing in the geographic area that are at least one of the one or more entities, and indicating any need for maintenance and cleaning of said equipment and assets; and
(c) tracking the utilization of equipment or assets on a patient-by-patient basis, said equipment or assets being at least one of the one or more entities, said tracking occurring as said equipment or assets have been moved away from the patient the equipment or assets were last used with, the entity infection tracking system capturing the tracking as a milestone event, and the entity infection tracking system automatically changing the status of the equipment or assets when equipment or assets are used, cleaned, or should be granted another status.

10. The method for disease vector transmission of claim 1, characterized in that it comprises the further steps of:
(i) identifying events to be undertaken by one or more entities in the process of an activity as one or more milestones related to said activity, said one or more milestones being identified as events that contribute to the spread of infection;
(ii) analyzing the tracking data to recognize when at least one of the one or more milestones is achieved by the one or more entities;
(iii) reviewing the one or more milestones to determine the effect of the activities of the one or more entities upon the spread of infection.

11. The method for disease vector transmission of claim 1, characterized in that it comprises the further step of utilizing the linked data to measure and analyze the efficacy of one or more existing policies and practices on an ongoing basis to identify one or more policy adherence measurements, and utilizing said one or more policy adherence measurements as evidence to revise policies and practices to enhance efforts to curtail the spread of infection, said one or more policy adherence measurements including at least one of the following: environmental cleaning time; environmental cleaning efficacy; hand hygiene compliance; hand hygiene efficacy; and equipment movement violations.

12. The method for disease vector transmission of claim 1, characterized in that it comprises the further step of utilizing the linked data and analysis of the linked data to identify one or more gaps in best and/or leading practices that could pertain to behaviours of one or more entities in the geographic area, said behaviours including at least one of the following: handling of equipment or assets; treatment of one or more patients; and physical design of spaces within the geographic area, said one or more gaps being identified by identifying patterns of infection in circumstances that are not clearly covered by existing policy including at least one of a high rate of infection among certain types of patients who share a room; and hand hygiene compliance rates indicating a source of the spread of infection.

13. The method for disease vector transmission of claim 1, characterized in that it comprises the further step of utilizing a historical analysis of the linked data to predict future patterns of infections within the geographic area including the further steps of:
(a) modeling at the level of infection between people that are one or more of the one or more entities by the application of individual-level models operable to model the transition between disease states in discrete time; and
(b) modeling so as to better understand one or more of the following: the factors related to the spread of infection; the directed responses to infection control; or other activities that can be tested and applied to reduce the spread of infectious disease.

14. A method for infection control by application of an infection tracking system, characterized in that it comprises the steps of:
(a) collecting data pertaining to a risk of infection as related to one or more individuals within a geographic area from one or more data sources;
(b) linking previously determined data pertaining to a risk of infection transmission as related to one or more assets or equipment the geographic area, as determined by previous studies that determined the likelihood which that equipment or asset type contributed to the disease vector transmission to other entities;
(c) determining the risk for the one or more individuals through the evaluation of one or more individual factors;
(d) determining the risk for the one or more assets or equipment through evaluation of one or more asset or equipment factors;
(e) utilizing the infection tracking system, the includes one or more computer processors operable to access the collected data and to an undertake an analysis of a risk of infection relating to the one or more individuals and the one or more assets and equipment; and
(f) generating one or more communications of the analysis of the risk of infection to at least one medical or infection control professional, said one or more communications indicating at least one of the following: one or more infection hot zone locations; risk of infection; potential infection spread; or one or more potential sources of infection.

15. The method for infection control of claim 14, characterized in that it comprises the further step of the at least one medical or infection control professional utilizing the communication to undertake at least one of the following steps: implementing early testing for the infection for one or more of the one or more individuals; providing treatment to any of the one or more individuals identified as infected; or isolating any of the one or more individuals identified as infected.

16. The method for infection control of claim 14, characterized in that it comprises the further step of utilizing at least one of the following as the one or more individual factors: age; gender; co-morbidities; drug treatments; clinical procedures; readmission from a hospital; case mix group; location, exposure to infection, and time of exposure; and entity exposure to infection and time of exposure.

17. The method for infection control of claim 14, characterized in that it comprises the further step of utilizing at least one of the following as the one or more asset or equipment factors: type of asset or equipment; design of asset or equipment; typical use scenarios for asset or equipment; and previous history where asset or equipment was determined likely to have contributed to the disease vector transmission to other of the one or more assets or equipment, or the one or more individuals.

18. The method for infection control of claim 14, characterized in that it comprises the further step of communicating the analysis of the risk of infection as at least one of the following:
(a) a detailed report listing providing information regarding the one or more individuals or one or more asset or equipment exposed to infection and one having a calculated risk of infection, said detailed report listing including at least one of the following: the time of exposure; the location of the exposure; the duration of the exposure; the current location of the exposed one or more individuals or one or more asset or equipment; and any an alert generated when a suspected or positive case of infection is identified;
(b) a visual representation of the risk of infection in real-time, near real-time, as historical data or as a prediction; or
(c) an electronic broadcast to one or more mobile devices.

19. A entity infection tracking system for infection control operable to analyze risk of infection within a geographic area, characterized in that it comprises:
(a) a centralized server including a storage area where data of the infection tracking system is stored;
(b) an entity tracking means linked to the centralized server, said entity tracking means being operable to track one or more entities within the geographic area, said tracking means including one or more tags attached to each of the one or more entities that continuously or intermittently transmit a tag location; and receivers that transmit the location data received from the one or more tags to the centralized server to generate tracking data;
(c) one or more access links whereby the centralized server may access one or more remote databases and capture data therefrom as additional data to be utilized by the infection tracking system;
(d) a risk analysis application, whereby the tracking data and any additional data is processed to produce a risk of infection analysis pertaining to the one or more entities is generated as risk analysis data;
(e) a communication means operable to communicate the risk analysis data to at least one medical professional or infection control professional as at least one of the following: a representation of the location of one or more infected entities; a mapping of one or more hot zones of infection within the geographic area; a mapping of a potential spread of infection calculated based on the risk analysis data.

20. The entity infection tracking system for infection control of claim 19, characterized in that it comprises the risk analysis application including a geospatial application operable to undertake at least one of the following: to store data from the tracking means, to communicate or analyze the data in real-time or near-real time; and to recognize contacts between the one or more entities over multiple degrees of connections.

21. The entity infection tracking system for infection control of claim 19, characterized in that it comprises the system being operable to recognize and calculate one or more of the following:
(a) direct intersections between the one or more entities with the geographic area, including intersections involving one of the one or more entities that is identified as potentially infected;
(b) indirect intersections between the one or more entities with the geographic area, whereby one or more the entities is in contact with another of the one or more entities that in a secondary, tertiary, or subsequent manner; or
(c) a first contact with an infected entity within a geographic area.

22. The entity infection tracking system for infection control of claim 19, characterized in that it comprises the communication means being operable to present data of the entity infection tracking system to a user in at least one of an electronic visual display or printed manner, to include at least one of the following: entity type, sub-type and identification of entity; degree of contact separation from the original entity; date and time of the contact with an infected entity; the length of time of the contact with the infected entity; the current location of the one or more entities, including any infected entity; the associated risk of any of the one or more entities acquiring an infection; and any other information collected or generated by the entity tracking system.

23. The entity infection tracking system for infection control of claim 19, characterized in that it comprises a pathogenic reservoir location determination module operable to facilitate the identification of one or more pathogenic reservoir locations within the geographic area, said one or more pathogenic reservoir locations having particular pathogens therein indicating a positive infection location.

24. The entity infection tracking system for infection control of claim 19, characterized in that it comprises a hand hygiene compliance module operable to:
(a) utilize the tracking data to facilitate the tracking of hand hygiene compliance within the geographic area, including at least the following: proximity of the one or more entities to a hand hygiene station; length of use of the hand hygiene station by the one or more entities; and determination of the status of the hand hygiene station use, said status may be captured further in the context of interactions with the one or more entities to indicate a possible risk of infection;
(b) communicate any occurrence relating to hand hygiene compliance within the geographic area in real-time, near real-time, as historical data or as a prediction as facilitated by the communication facility;
(c) evaluate compliance and effectiveness of hand hygiene as indicated in accordance with activity of the one or more entities prior to utilizing the hand hygiene station, including any patient contact; and
(d) provide data to facilitate a review of one or more existing policies to promote improvements in effective hand hygiene within the geographic area.

25. The entity infection tracking system for infection control of claim 24, characterized in that a status of hand hygiene compliance may be triggered for the one or more entities upon certain activities, including at least contact with a patient, and one or more alerts may be generated and communicated by the system upon an event of activity without the necessary hand hygiene compliance status preceding the activity.
